(19) United States
(12) Patent Application Publication
(10) Pub. No.: US 2026/0326771 A1
(43) Pub. Date: Oct. 22, 2026

(54) VEHICLE VIBRATION TRANSFER WITH MACHINE LEARNING

(71) Applicant: Ford Global Technologies, LLC, Dearborn, MI (US)

(72) Inventors: Amirhassan Abbasi, Farmington, MI (US); Arianna Duraku, Shelby Township, MI (US); Matt Black, Manchester, MI (US); Karen Willard, Grosse Pointe Farms, MI (US); Satheesh Kumar Chandran, Livonia, MI (US); Vicky Svidenko, Newcastle, WA (US)

(73) Assignee: Ford Global Technologies, LLC, Dearborn, MI (US)

(21) Appl. No.: 19/180,486

(22) Filed: Apr. 16, 2025

(51) Int. Cl. B60W 50/00; G06N 20/00

(52) U.S. Cl. CPC B60W 50/0098; G06N 20/00; B60W 2050/0031; B60W 2050/0052; B60W 2420/10; B60W 2420/905; B60W 2520/10

(57) ABSTRACT

A first vehicle includes a coupled dynamic system including a first component and a second component. A computer is programmed to receive first vibration data detected by a first vibration sensor mounted to the first component, execute a machine-learning model to determine a quantity of vibrational energy transferred to the second component, and actuate a third component of the first vehicle based on the quantity of vibrational energy. The first vibration sensor is of a first type. The second component of the first vehicle lacks any vibration sensor mounted thereto. The first vibration data is an input to the machine-learning model. The machine-learning model is trained to match ground-truth vibration data generated by a second vibration sensor mounted to the second component of a second vehicle. The second vibration sensor is of a second type different than the first type.

### BACKGROUND

When traveling, vehicles experience vibrations from the road. These vibrations can have numerous effects on vehicles, such as real-time effects on handling as well as long-term effects on longevity of the components.

### BRIEF DESCRIPTION OF THE DRAWINGS

FIG. 1 is a perspective view of an example mechanical system of an example vehicle.

FIG. 2 is a block diagram of an example control system of the vehicle.

FIG. 3 is a flowchart of an example process for training a machine-learning model for tracking vibrational-energy transfer to components of the vehicle.

FIG. 4 is a flowchart of an example process for tracking the vibrational-energy transfer to the components of the vehicle.

### DETAILED DESCRIPTION

This disclosure pertains to actuating a vehicle based on tracking vibrational energy transferred to components of a coupled dynamic system of the vehicle. The system is “coupled” in that it includes multiple components coupled together and “dynamic” in that state variables of the components change with time relative to each other or the rest of the vehicle or a fixed reference frame. The coupled dynamic system may be, for example, a suspension system for a wheel of the vehicle or another underbody system that experiences road vibrations. A computer is programmed to receive first vibrational data detected by a first vibration sensor mounted to a first component of the coupled dynamic system and to input the first vibrational data into a machine-learning model. The machine-learning model then outputs a quantity of vibrational energy transferred to a second component of the coupled dynamic system (or multiple quantities for multiple second components). The vehicle may lack vibration sensors on the second component. Finally, the computer actuates a third component of the vehicle based on the quantity of vibrational energy. The machine-learning model is trained to match ground-truth vibration data generated by a second vibration sensor mounted to the second component in a test vehicle. The training of the machine-learning model allows for vibrational-energy estimation for components without vibration sensors by modeling the transmission of vibrational energy through the coupled dynamic system. This disclosure provides techniques for modeling the energy transfer in a multi-component coupled dynamic system with a combination of data-driven techniques (including the machine-learning model) and physics-based modeling (e.g., modal analysis, coherence, etc.). The second vibration sensor used for gathering the ground-truth data in the test vehicle is a different type than the first vibration sensor mounted on the first component of the vehicle. This difference in types may allow the machine-learning model to mimic a more accurate type of sensor.

A computer includes a processor and a memory, and the memory stores instructions executable by the processor to receive first vibration data detected by a first vibration sensor, execute a machine-learning model to determine a quantity of vibrational energy transferred to a second component, and actuate a third component of the first vehicle based on the quantity of vibrational energy. The first vibration sensor is of a first type. The first vibration sensor is mounted to a first component of a first vehicle. The first vehicle includes a coupled dynamic system including the first component and the second component. The second component of the first vehicle lacks any vibration sensor mounted thereto. The first vibration data is an input to the machine-learning model. The machine-learning model is trained to match ground-truth vibration data generated by a second vibration sensor. The second vibration sensor is mounted to the second component of a second vehicle. The second vibration sensor is of a second type different than the first type.

In an example, the first type may be a road noise cancellation (RNC) accelerometer.

In an example, the second type may be an internal circuit piezoelectric (ICP) sensor.

In an example, the coupled dynamic system may include a plurality of second components including the second component, each of the second components lacking any vibration sensor mounted thereto, and the machine-learning model may be trained to match the ground-truth vibration data generated by a plurality of second vibration sensors respectively mounted to the second components. In a further example, the machine-learning model may be a one-to-many regression model.

In another further example, each second vibration sensor may be of the second type.

In an example, the coupled dynamic system may be a suspension system of a wheel of the first vehicle. In a further example, the first component may be a control arm.

In an example, before training the machine-learning model, the ground-truth vibration data may be processed by applying a bandpass filter. In a further example, a frequency band of the bandpass filter may be based on a coherence analysis of the ground-truth vibration data.

In an example, the instructions may further include instructions to actuate the third component in response to the quantity of vibrational energy exceeding a threshold.

In an example, the instructions to receive the first vibration data may include instructions to receive the first vibration data from a buffer on board the first vehicle. In a further example, the instructions may further include instructions to store the first vibration data in the buffer in response to an activation condition being satisfied. In a still further example, the activation condition may be based on a speed at which the first vehicle is traveling.

A method includes training a machine-learning model to match ground-truth vibration data generated by a second vibration sensor, receiving first vibration data detected by a first vibration sensor, executing the machine-learning model to determine a quantity of vibrational energy transferred to a second component, and actuating a third component of a first vehicle based on the quantity of vibrational energy. The second vibration sensor is mounted to the second component of a second vehicle. The second vibration sensor is of a second type. The first vibration sensor is of a first type different than the second type. The first vibration sensor is mounted to a first component of the first vehicle. The first vehicle includes a coupled dynamic system including the first component and the second component. The second component of the first vehicle lacks any vibration sensor mounted thereto. The first vibration data is an input to the machine-learning model.

In an example, the first type may be a road noise cancellation (RNC) accelerometer, and the second type may be an internal circuit piezoelectric (ICP) sensor.

In an example, the coupled dynamic system may include a plurality of second components including the second component, each of the second components lacking any vibration sensor mounted thereto; the machine-learning model may be trained to match the ground-truth vibration data generated by a plurality of second vibration sensors respectively mounted to the second components; and each second vibration sensor may be of the second type. In a further example, the machine-learning model may be a one-to-many regression model.

In an example, the coupled dynamic system may be a suspension system of a wheel of the first vehicle, and the first component may be a control arm.

In an example, the method may further include, before training the machine-learning model, processing the ground-truth vibration data by applying a bandpass filter, and a frequency band of the bandpass filter may be based on a coherence analysis of the ground-truth vibration data.

With reference to the Figures, wherein like numerals indicate like parts throughout the several views, a first vehicle 100a includes a coupled dynamic system 115 including a first component 120 and a second component 125. A first vibration sensor 105 is mounted to the first component 120 of the first vehicle 100a. The second component 125 of the first vehicle 100a lacks any vibration sensor mounted thereto. A computer 205, 210 includes a processor and a memory, and the memory stores instructions executable by the processor to receive first vibration data detected by the first vibration sensor 105, execute a machine-learning model to determine a quantity of vibrational energy transferred to the second component 125, and actuate a third component of the first vehicle 100a based on the quantity of vibrational energy. The first vibration sensor 105 is of a first type. The first vibration data is an input to the machine-learning model. The machine-learning model is trained to match ground-truth vibration data generated by a second vibration sensor 110. The second vibration sensor 110 is mounted to the second component 125 of a second vehicle 100b. The second vibration sensor 110 is of a second type different than the first type.

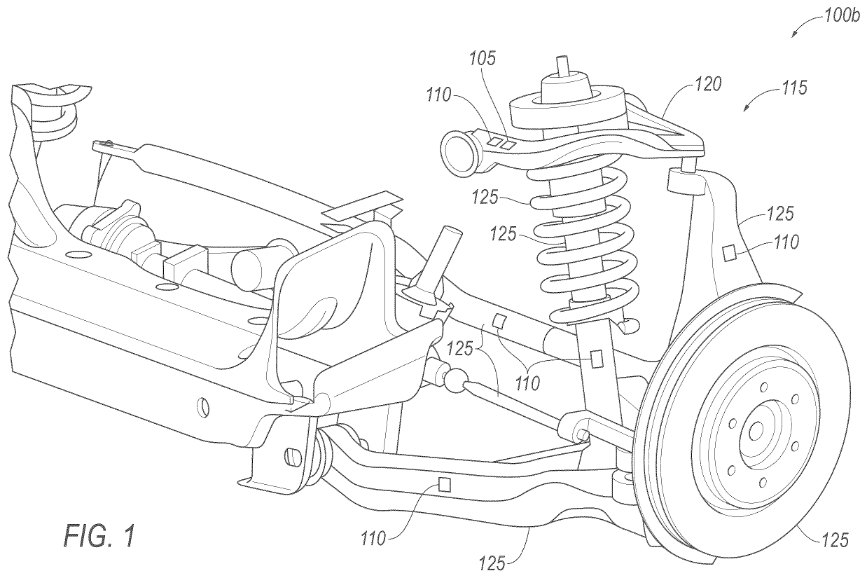

FIG. 1 shows a portion of the second vehicle 100b. The second vehicle 100b may be any passenger or commercial automobile such as a car, a truck, a sport utility vehicle, a crossover, a van, a minivan, a taxi, a bus, etc. The second vehicle 100b includes the coupled dynamic system 115, the first vibration sensors 105, and the second vibration sensors 110. The second vehicle 100b (or multiple second vehicles 100b) are used for gathering data for training the machine-learning model, as described below.

The first vehicle 100a is a vehicle for which the trained machine-learning model is executed. The first vehicle 100a may be any passenger or commercial automobile such as a car, a truck, a sport utility vehicle, a crossover, a van, a minivan, a taxi, a bus, etc. The first vehicle 100a may be the same model of vehicle as the second vehicle 100b. The first vehicle 100a may include the same components as the first vehicle 100a, except the first vehicle 100a lacks the second vibration sensors 110. Other than the second vibration sensors 110, the descriptions of components below are applicable to both the first vehicle 100a and the second vehicle 100b. References to “vehicle” apply to both the first vehicle 100a and the second vehicle 100b.

The coupled dynamic system 115 includes the first component 120 and one or a plurality of second components 125. The components 120, 125 of the coupled dynamic system 115 are mechanically coupled together, and at least some of the components 120, 125 are movable relative to other components 120, 125, thereby making the coupled dynamic system 115 dynamic. Each pair of components 120, 125 may be mechanically coupled together directly or indirectly via other components 120, 125 of the coupled dynamic system 115. The coupled dynamic system 115 may be a mechanical system of the vehicle 100. Vibrations from sources such as the road over which the vehicle 100 is traveling can be transmitted between the components 120, 125 of the coupled dynamic system 115. The coupled dynamic system 115 may be part of an underbody of the vehicle 100, which experiences a comparatively high amount of road vibrations. The components 120, 125 may be interconnected in different ways and at different points and may have different shapes, providing a variety of paths and resonant frequencies through which the input vibrations can travel. How vibrations travel through the coupled dynamic system 115 may be a complex, nonlinear system.

For example, the coupled dynamic system 115 may be a suspension system of a wheel of the vehicle 100. The components 120, 125 of a suspension system may include a wheel hub, a wheel bearing, upper control arm, lower control arm, steering gear, ball joint, sway bar, tie rod, shock, spring pad, electric motor, motor mount, etc. The first component 120 may be a control arm, which connects the wheel assembly to the frame of the vehicle 100 and thereby transmits the road vibrations to the frame. The second components 125 may be the remaining components of the suspension system.

The first vibration sensors 105 are of a first type, and the second vibration sensors 110 are of a second type different than the first type. The second type may have greater resolution, lower noise, a faster refresh rate, or some other advantage compared to the first type in terms of the data generated. The first type may have wider availability, greater durability, or some other advantage compared to the second type in terms of being installed on production vehicles. Accordingly, the first type may be a road noise cancellation (RNC) accelerometer, and the second type may be an internal circuit piezoelectric (ICP) sensor.

The first vibration sensor 105 is mounted to the first component 120 of the vehicle 100, and the second vibration sensors 110 are mounted to the second components 125 of the second vehicle 100b (as well as possibly to the first component 120). The term “first component” is used herein for the component to which the first vibration sensor 105 is mounted, and the term “second component” is used herein for the components of the coupled dynamic system 115 lacking a first vibration sensor 105. The first vibration sensor 105 may be placed on a component experiencing a comparatively high or undispersed amount of road vibrations, such one of the control arms, in order to gather an accurate assessment of the inputted road vibrations. The second vibration sensors 110 may be placed on the components 120, 125 to gather the vibrational energy transmitted to those components 120, 125. The vehicle 100 may include multiple first vibration sensors 105, such as one first vibration sensor 105 for each coupled dynamic system 115 of interest in the vehicle 100.

On the first vehicle 100a, the first vibration sensor 105 is mounted to the first component 120, and each of the second components 125 lacks any vibration sensor mounted thereto. The first vehicle 100a may lack any second vibration sensors 110 (i.e., any vibration sensors of the second type). As described below, the machine-learning model may be trained to determine quantities of vibrational energy transferred to the second components 125 based on the input from the first vibrational sensor on the first component 120. The computer 205, 210 can thus track the vibrational energy imparted to the second components 125 even without vibrational sensors on the second components 125, simplifying construction of the first vehicle 100a.

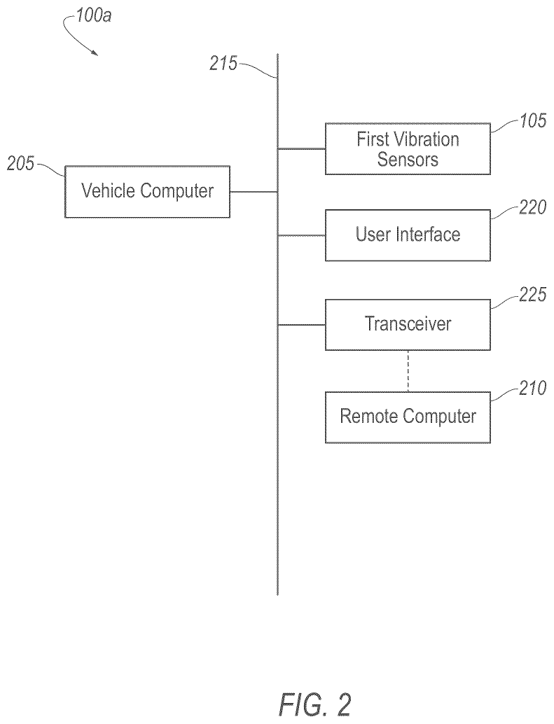

With reference to FIG. 2, the first vehicle 100a includes a vehicle computer 205, a communications network 215, the first vibration sensors 105, a user interface 220, and a transceiver 225. The transceiver 225 may be in communication with a remote computer 210. The term “computer” may refer to either the vehicle computer 205 or the remote computer 210.

The vehicle computer 205 is a microprocessor-based computing device such as a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). The vehicle computer 205 can thus include a processor, a memory, etc. The memory of the vehicle computer 205 can include media for storing instructions executable by the processor as well as for electronically storing data and/or databases, and/or the vehicle computer 205 can include structures such as the foregoing by which programming is provided. The vehicle computer 205 can be multiple computers coupled together on board the first vehicle 100a.

The vehicle computer 205 may transmit and receive data through the communications network 215. The communications network 215 may be a controller area network (CAN) bus, Ethernet, WiFi, Local Interconnect Network (LIN), onboard diagnostics connector (OBD-II), and/or any other wired or wireless communications network. The vehicle computer 205 may be communicatively coupled to the first vibration sensors 105, the user interface 220, the transceiver 225, and other electronic components via the communications network 215.

The user interface 220 presents information to and receives information from an operator of the vehicle 100. The user interface 220 may be located on an instrument panel in a passenger compartment of the first vehicle 100a, and/or wherever may be readily seen by the operator. The user interface 220 may include dials, digital readouts, screens, speakers, and so on for providing information to the operator, such as human-machine interface (HMI) elements such as are known. The user interface 220 may include buttons, knobs, keypads, microphone, and so on for receiving information from the operator.

The transceiver 225 may be adapted to transmit signals wirelessly through any suitable wireless communication protocol, such as cellular, Bluetooth®, Bluetooth® Low Energy (BLE), ultra-wideband (UWB), WiFi, IEEE 802.11a/b/g/p, cellular-V2X (CV2X), Dedicated Short-Range Communications (DSRC), other RF (radio frequency) communications, etc. The transceiver 225 may be adapted to communicate with a remote server, that is, a server distinct and spaced from the vehicle 100. The remote server may be located outside the vehicle 100. For example, the remote server may be associated with another vehicle (e.g., V2V communications), an infrastructure component (e.g., V2I communications), a first responder, a mobile device associated with the operator of the vehicle 100, etc. The transceiver 225 may be one device or may include a separate transmitter and receiver.

The remote computer 210 is a microprocessor-based computing device such as a generic computing device including a processor and a memory. The memory of the remote computer 210 can include media for storing instructions executable by the processor as well as for electronically storing data and/or databases, and/or the remote computer 210 can include structures such as the foregoing by which programming is provided. The remote computer 210 can be multiple computers coupled together. The remote computer 210 is distinct from and spaced from the vehicle 100.

Returning to FIG. 1, the machine-learning model is trained to match ground-truth vibration data generated by one or more second vibration sensors 110 respectively mounted to the second components 125. As a general overview, one or more second vehicles 100b are put through a set of testing conditions, during which vibration data is received from the first vibration sensor 105 and the second vibration sensors 110. The vibration data from the first vibration sensors 105 is the input for the machine-learning model, and the vibration data from the second vibration sensors 110 is the ground-truth data for the machine-learning model. Before training the machine-learning model, the ground-truth vibration data is processed in one or more processing steps. The vibration data is subjected to preprocessing. A coherence analysis is performed on the preprocessed data, resulting in a local mode for each second component 125. A bandpass filter is applied to the vibration data from each second vibration sensor 110 to isolate the respective local mode. Then, the machine-learning model is trained to match the isolated local mode of vibration (or extracted statistical features from vibration data band-passed through the local modes) of each second component 125, using the corresponding first vibration data from the first vibration sensor 105 as the input. After training is complete, the machine-learning model is validated and then installed on the computer 205, 210 for use with the first vehicle 100a.

The second vehicle 100b may be placed in a testing setup for simulating road travel, such as a dynamometer. The second vibration sensors 110 may be attached to the second vehicle 100b and remain on the second vehicle 100b for the duration of testing. The second vehicle 100b is run through a variety of testing conditions. For example, the second vehicle 100b may run at each of a set of constant speeds for a preset duration. The constant speeds may be, for example, increments of 5 miles per hour (mph) from 10 mph to 60 mph. First vibration data and raw second vibration data are received and recorded from the first vibration sensors 105 and second vibration sensors 110, respectively, during each test run. To increase the dataset, the testing conditions may be repeated for multiple second vehicles 100b.

Each first vibration sensor 105 and second vibration sensor 110 may generate one or more dimensions of acceleration at regular time intervals. For example, the vibration data from each vibration sensor 105, 110 may be three linear dimensions of acceleration at each time interval, as in (aₓ₁, a_{y1}, a_{z1}) at t₁, (aₓ₂, a_{y2}, a_{z2}) at t₂, etc. The streams of vibration data from the first vibration sensors 105 and second vibration sensors 110 may be synchronized in time (e.g., generate data points at the same time intervals t₁, t₂, etc.).

The raw second vibration data is preprocessed through one or more preprocessing steps. For example, downsampling and/or low-pass filtering (e.g., recursive low-pass filtering) are performed for removing noise from the vibration data. The frequencies removed may be chosen to be known frequencies of noise in road vibration data. A bandpass filter may be applied to remove DC bias. A finite impulse response (FIR) bandpass filter may be used to remove global modes of the coupled dynamic system 115. A global mode is a mode in which a system as a whole executes coherent oscillations in time.

After preprocessing, a coherence analysis is performed on the second vibration data. The term “coherence” is used herein in its signal processing sense of a statistic measuring the relationship between two signals or data sets. The coherence between two signals is the ratio of the square of the cross-spectral density of the two signals to the product of the auto-spectral densities of the two signals, as in the following expression:

$${C}_{ab} ( f ) = \frac{{\vert {G}_{ab} ( f ) \vert}^{2}}{{G}_{aa} ( f ) {G}_{bb} ( f )}$$

in which a(t) and b(t) are the two signals, ƒ is frequency, C_{ab} is the coherence of a and b, Gab is the cross-spectral density of a and b, Gₐₐ is the auto-spectral density of a, and G_{bb} is the auto-spectral density of b. In this case, a and b may each be a dimension of the second vibration data from the same or different second vibration sensors 110 (e.g., a may be lateral acceleration detected by the second vibration sensor 110 on the upper control arm and b may be vertical acceleration detected by the second vibration sensor 110 on the shock). The coherence may be determined for each pair of dimensions from the second vibration data.

Before training the machine-learning model, the ground-truth vibration data is processed by applying a bandpass filter based on the coherence analysis. A bandpass filter passes frequencies through that are within a frequency band and rejects or attenuates frequencies outside the frequency band. The frequency band of the bandpass filter is based on the coherence analysis of the ground-truth vibration data. The frequency band encompasses a local mode of the second component 125 relative to the first component 120, as indicated by the coherences between the dimensions of the second component 125 and the dimensions of the first component 120 (e.g., C_{(2nd,i)(1st,j)} for all i∈{x, y, z}, j∈{x, y, z}, in which the subscript “2nd” indicates the second component 125, the subscript “1st” indicates the first component 120, the subscripts i and j are indexes, and x, y, and z are spatial dimensions). After the coherence analysis, the second vibration data from the second component 125 is bandpassed using fast Fourier transform (FFT) for the second component 125 to the frequency range with the highest coherence to the first component 120. Then, the inverse fast Fourier transform (iFFT) is used to transfer back the second vibration data and reconstruct the time response for each second component 125 representing the time-domain behavior of that second component 125 in a condition with the highest coherence with the first component 120. Upon transforming to the frequency domain by FFT and transforming back to the time domain by iFFT, the second vibration data will include the time response of the second component 125 at its first local mode. The foregoing steps can be performed independently for each second component 125.

The machine-learning model receives the first vibration data or statistical features extracted from the first vibration data as an input and determines a plurality of respective quantities of vibrational energy transferred to the respective second components 125, as in the following expression:

y_{est,t}=ƒ(xₜ;Θ)

in which y_{est,t} is a vector of quantities of vibrational energy for the second components 125 at timestep t, ƒ( ) is the machine-learning model, xₜ is a vector of the dimensions of the first vibration or statistical features extracted from the first vibration data at timestep t, and Θ are the parameters of the machine-learning model. For example, y_{est,t} may be a vector with the dimensions of acceleration at each second component 125 concatenated together (e.g., (a_{x2nd_1}, a_{y2nd_1}, a_{z2nd_1}, a_{x2nd_2}, a_{y2nd_2}, a_{z2nd_2}, . . . a_{x2nd_i}, a_{y2nd_i}, a_{z2nd_i}, . . . ) in which the subscript “2nd_i” indicates the ith second component 125).

The machine-learning model may be a one-to-many regression model, in other words, a machine-learning model taking data about a single entity as an input (e.g., a single vector xₜ for the first component 120) and outputting data about multiple entities (e.g., multiple vectors y_{est,t} for the second components 125). The machine-learning model may be any suitable type for one-to-many regressions, such as a neural network. A neural network is useful for modeling the nonlinear relationships involved in vibrations moving through the coupled dynamic system 115. For a neural network, the parameters Θ may be a set of weights of connections between nodes in the neural network.

The machine-learning model is trained to match ground-truth vibration data generated by the one or more second vibration sensors 110 respectively mounted to the second components 125. For example, the parameters Θ may be adjusted to minimize a loss function. The loss function may be the mean squared error, as given in the following expression:

$$ℒ ( Θ ) = \frac{1}{{n}_{train}} {\sum }_{t = 1}^{{n}_{train}} {‖ {y}_{t} - f ( {x}_{t} ; Θ ) ‖}^{2}$$

in which [symbol] is the loss, nₜᵣₐᵢₙ is the number of data points in the training data, and yₜ is the ground-truth vector of quantities of vibrational energy for the second components 125 at timestep t. The training is an optimization scenario in which the parameters are selected to minimize the loss, as given in the following expression:

$${Θ}^{*} = {arg min}_{Θ} ℒ ( Θ )$$

in which Θ* is the set of optimized parameters. The optimization scenario can be solved using any suitable optimization algorithm such as gradient descent, stochastic gradient descent, Adam, etc.

Before deploying the machine-learning model, the machine-learning model may be validated. For example, only a portion of the first vibration data and second vibration data may be used for training as described above (e.g., 70%), and the remainder may be used for validation (e.g., 30%). The machine-learning model may be validated using the same loss function as described above, as given in the following expression:

$${ℒ}_{test} = \frac{1}{{n}_{test}} {\sum }_{t = 1}^{{n}_{test}} {‖ {y}_{t} - f ( {x}_{t} ; {Θ}^{*} ) ‖}^{2}$$

The machine-learning model may only be deployed if the loss function is minimized or test loss [symbol] is below a prechosen threshold. Once trained and validated, the machine-learning model may be integrated and deployed on one of the vehicle computer 205 or the remote computer 210.

As a general overview of tracking the vibrations in the first vehicle 100a, the first vibration sensor 105 detects the first vibration data. The vehicle computer 205 may store the first vibration data in a buffer on board the first vehicle 100a in response to an activation condition being satisfied. The computer 205, 210 receives the first vibration data from the buffer. In response to an analysis condition being satisfied, the computer 205, 210 executes the machine-learning model. The computer 205, 210 actuates the third component based on the quantities of vibrational energy outputted by the machine-learning model (e.g., in response to one of the quantities exceeding a threshold).

The steps below may be performed by the vehicle computer 205, by the remote computer 210, or partially by the vehicle computer 205 and partially by the remote computer 210. For example, if the machine-learning model is installed on the remote computer 210, the vehicle computer 205 may perform initial steps (including storing the first vibration data in the buffer and testing whether the analysis condition is met) and then actuate the transceiver 225 to transmit the data generated in the initial steps to the remote computer 210 (e.g., in response to the analysis condition being satisfied). Then, the remote computer 210 may perform intermediate steps (including executing the machine-learning model) and transmit the results of the intermediate steps to the vehicle computer 205. Finally, the vehicle computer 205 may perform final steps (including actuating the third component). Alternatively, if the machine-learning model is installed on the vehicle computer 205, the vehicle computer 205 may perform all the steps.

The vehicle computer 205 may determine whether an activation condition is satisfied. The activation condition may be chosen to indicate similar conditions to the testing conditions for training the machine-learning model, and/or to minimize noise in the first vibration data. For example, the activation condition may be based on the speed at which the first vehicle 100a is traveling (e.g., that the speed is remaining constant). The activation condition may also be based on ambient temperature, tire pressures, steering-wheel angle, train weight (i.e., combined weight on a bed of the first vehicle 100a and weight being towed), etc.

In response to the activation condition being satisfied, the vehicle computer 205 may store the first vibration data in the buffer on board the first vehicle 100a. The buffer may be designated portion of the memory of the vehicle computer 205. The buffer may be used to collect a sufficiently large set of the first vibration data for executing the machine-learning model. The vehicle computer 205 may continue storing additional first vibration data in the buffer for as long as the activation condition is satisfied and cease storing additional first vibration data in the buffer in response to the activation condition no longer being satisfied.

The vehicle computer 205 may determine whether an analysis condition is satisfied. The analysis condition may be chosen to occur regularly and at a frequency that permits a sufficiently large set of the first vibration data to be collected. For example, the analysis condition may be the first vehicle 100a turning off (i.e., a trip of the first vehicle 100a being completed). For the purposes of this disclosure, “on state” is defined as the state of the first vehicle 100a in which full electrical energy is provided to electrical components of the first vehicle 100a and the first vehicle 100a is ready to be driven (e.g., the engine is running); “off state” is defined as the state of the first vehicle 100a in which a low amount of electrical energy is provided to selected electrical components of the first vehicle 100a, typically used when the first vehicle 100a is being stored; and “accessory-power state” is defined as the state of the first vehicle 100a in which full electrical energy is provided to more electrical components than in the off state and the first vehicle 100a is not ready to be driven. Typically, an operator puts the first vehicle 100a into the on state when the operator is going to operate the first vehicle 100a, puts the first vehicle 100a into the off state when the operator is going to leave the first vehicle 100a, and puts the first vehicle 100a into the accessory-power state when the operator is going to sit in but not operate the first vehicle 100a. The analysis condition may be satisfied when the first vehicle 100a transitions from the on state to the off state.

In response to the analysis condition being satisfied, the computer 205, 210 receives the vibration data from the buffer on board the vehicle 100. For example, the vehicle computer 205 may read the first vibration data from the buffer in order to execute the machine-learning model. For another example, the vehicle computer 205 may actuate the transceiver 225 to transmit the first vibration data from the buffer to the remote computer 210, and the remote computer 210 receives the first vibration data.

The computer 205, 210 executes the machine-learning model to determine quantities of vibrational energy transferred to the second components 125, as described above. The first vibration data received from the buffer is an input to the machine-learning model. The quantity can be converted to a related quantity to be more useful for a desired assessment of the second component 125. For example, the quantity may be converted to cumulative energy transferred to the second component 125 over a life of the second component 125, which is useful for assessing a longevity of the second component 125. For another example, the quantity may be converted to a peak amount of energy transferred to the second component 125 during a single driving maneuver, which is useful for assessing the driving maneuver.

The vehicle computer 205 actuates a third component of the first vehicle 100a based on the quantity of vibrational energy. For example, the vehicle computer 205 may actuate the third component in response to the quantity of vibrational energy exceeding a threshold. The threshold may be a preset value stored in the memory of the vehicle computer 205. The quantity of vibrational energy may be an accumulated energy transferred to the second component 125, and the threshold may be chosen to indicate that a proportion of the longevity of the second component 125 has been expended (e.g., 85%). The quantity of vibrational energy may be the peak amount of energy transferred to the second component 125 during a single driving maneuver, and the threshold may be chosen to indicate that the maneuver is not recommended.

For example, the third component may be the user interface 220, and the vehicle computer 205 may actuate the user interface 220 to output a message. The message can indicate that the quantity of vibrational energy exceeded the threshold. Alternatively, the third component may control motion of the first vehicle 100a (e.g., a propulsion system), and the vehicle computer 205 may actuate the third component to mitigate vibrational energy imparted to the second component 125 (e.g., by capping a magnitude of a value defining a maneuver of the first vehicle 100a).

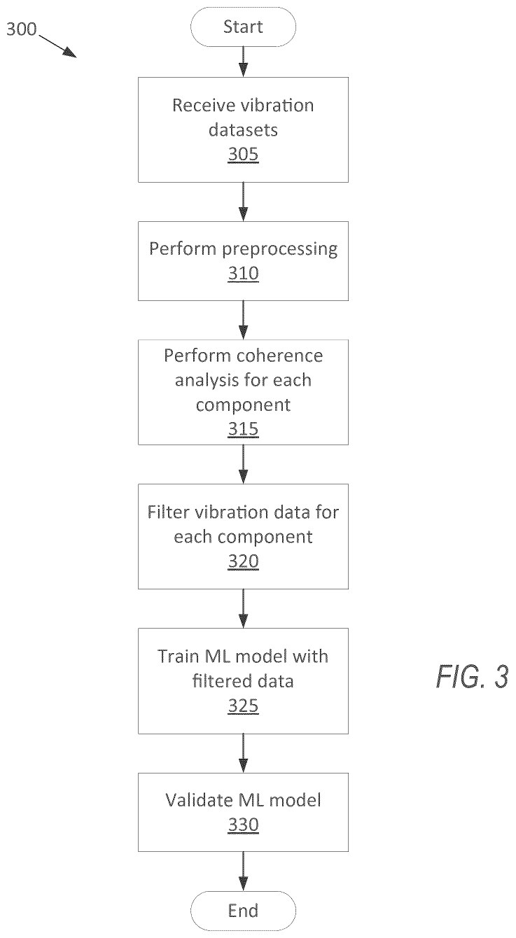

FIG. 3 is a flowchart illustrating an example process 300 for training the machine-learning model for tracking vibrational-energy transfer to the second components 125 of the vehicle 100. The memory of the remote computer 210 stores executable instructions for performing the steps of the process 300 and/or programming can be implemented in structures such as mentioned above. The remote computer 210 running the training may be different than the remote computer 210 on which the trained machine-learning model may be installed. As a general overview of the process 300, the remote computer 210 receives the first vibration data and second vibration data, performs preprocessing steps, performs coherence analysis for the components, filters the second vibration data based on the coherence analysis, trains the machine-learning model, and validates the machine-learning model.

The process 300 begins in a block 305, in which the remote computer 210 receives the first vibration data and the second vibration data generated during the test runs, as described above.

Next, in a block 310, the remote computer 210 performs the preprocessing steps, as described above.

Next, in a block 315, the remote computer 210 performs the coherence analysis, as described above.

Next, in a block 320, the remote computer 210 applies a bandpass filter to the second vibration data based on the coherence analysis, as described above.

Next, in a block 325, the remote computer 210 trains the machine-learning model, as described above.

Next, in a block 330, the remote computer 210 validates the machine-learning model, as described above. After the block 330, the process 300 ends.

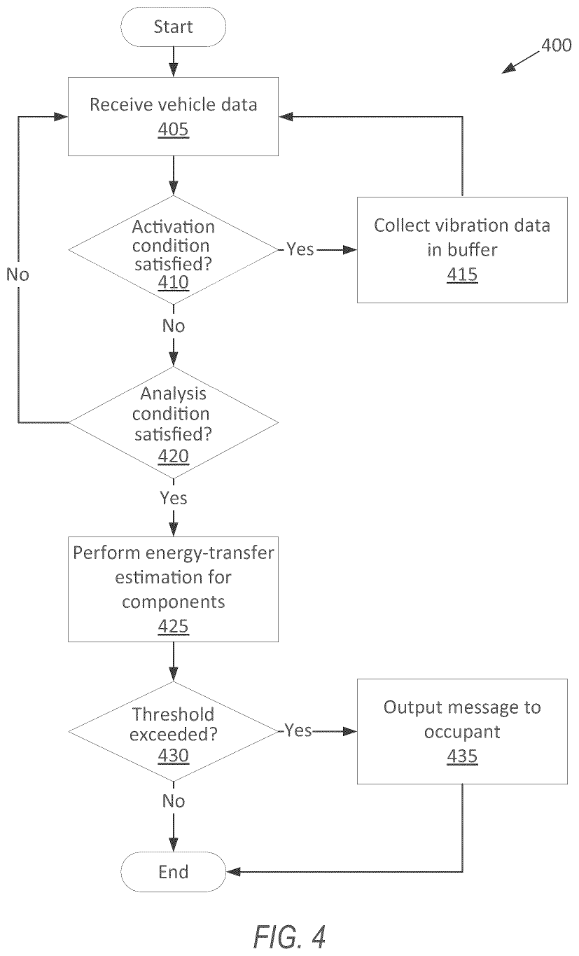

FIG. 4 is a flowchart illustrating an example process 400 for tracking the vibrational-energy transfer to the second components 125 of the first vehicle 100a. The memory of the computer 205, 210 stores executable instructions for performing the steps of the process 400 and/or programming can be implemented in structures such as mentioned above. As a general overview of the process 400, the computer 205, 210 receives vehicle data. As long as the activation condition is satisfied, the computer 205, 210 stores the first vibration data in the buffer. In response to the analysis condition being satisfied, the computer 205, 210 executes the machine-learning model. In response to the quantity of vibrational energy exceeding the threshold, the computer 205, 210 actuates the third component.

The process 400 begins in a block 405, in which the computer 205, 210 receives vehicle data. The vehicle data includes the first vibration data generated by the first vibration sensor 105. The vehicle data may further include data used for evaluating the activation condition and/or the analysis condition. For example, the vehicle data may include the speed at which the first vehicle 100a is traveling, ambient temperature, tire pressures, steering-wheel angle, train weight, ignition state, etc.

Next, in a decision block 410, the computer 205, 210 determines whether the activation condition is satisfied, as described above. In response to the activation condition being satisfied, the process 400 proceeds to a block 415. In response to the activation condition not being satisfied, the process 400 proceeds to a decision block 420.

In the block 415, the computer 205, 210 stores the first vibration data in the buffer, as described above. After the block 415, the process 400 returns to the block 405 to continue collecting vehicle data.

In the decision block 420, the computer 205, 210 determines whether the analysis condition is satisfied, as described above. In response to the analysis condition being satisfied, the process 400 proceeds to a block 425. In response to the analysis condition not being satisfied, the process 400 returns to the block 405 to continue collecting vehicle data until the analysis condition is satisfied.

In the block 425, the computer 205, 210 receives the first vibration data from the buffer and executes the machine-learning model to determine the quantities of vibrational energy transferred to the second components 125, as described above.

Next, in a decision block 430, the computer 205, 210 determines whether any of the quantities of vibrational energy exceed the threshold, as described above. In response to at least one quantity of vibrational energy exceeding the threshold, the process 400 proceeds to a block 435. In response to none of the quantities of vibrational energy exceeding the threshold, the process 400 ends.

In the block 435, the computer 205, 210 actuates the third component, as described above. After the block 435, the process 400 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. Use of “in response to,” “upon determining,” “upon transforming,” etc. indicates a causal relationship, not merely a temporal relationship. The adjectives “first,” “second,” and “third” are used throughout this document as identifiers and are not intended to signify importance, order, or quantity. Many modifications and variations of the present disclosure are possible in light of the above teachings, and the disclosure may be practiced otherwise than as specifically described.

1. A computer comprising a processor and a memory, the memory storing instructions executable by the processor to:
receive first vibration data detected by a first vibration sensor, the first vibration sensor being of a first type, the first vibration sensor being mounted to a first component of a first vehicle, the first vehicle including a coupled dynamic system including the first component and a second component, the second component of the first vehicle lacking any vibration sensor mounted thereto;
execute a machine-learning model to determine a numerical quantity of vibrational energy transferred to the second component, the first vibration data being an input to the machine-learning model, the numerical quantity of vibrational energy being specific to the second component of the first vehicle; and
actuate a third component of the first vehicle based on the numerical quantity of vibrational energy;
wherein the machine-learning model is trained to match ground-truth vibration data generated by a second vibration sensor, the second vibration sensor being mounted to the second component of a second vehicle, the second vibration sensor being of a second type different than the first type.

2. The computer of claim 1, wherein the first type is a road noise cancellation (RNC) accelerometer.

3. The computer of claim 1, wherein the second type is an internal circuit piezoelectric (ICP) sensor.

4. The computer of claim 1, wherein:
the coupled dynamic system includes a plurality of second components including the second component, each of the second components lacking any vibration sensor mounted thereto; and
the machine-learning model is trained to match the ground-truth vibration data generated by a plurality of second vibration sensors respectively mounted to the second components.

5. The computer of claim 4, wherein the machine-learning model is a one-to-many regression model.

6. The computer of claim 4, wherein each second vibration sensor is of the second type.

7. The computer of claim 1, wherein the coupled dynamic system is a suspension system of a wheel of the first vehicle.

8. The computer of claim 7, wherein the first component is a control arm.

9. The computer of claim 1, wherein, before training the machine-learning model, the ground-truth vibration data is processed by applying a bandpass filter.

10. The computer of claim 9, wherein a frequency band of the bandpass filter is based on a coherence analysis of the ground-truth vibration data.

11. The computer of claim 1, wherein the instructions further include instructions to actuate the third component in response to the numerical quantity of vibrational energy exceeding a threshold.

12. The computer of claim 1, wherein the instructions to receive the first vibration data include instructions to receive the first vibration data from a buffer on board the first vehicle.

13. The computer of claim 12, wherein the instructions further include instructions to store the first vibration data in the buffer in response to an activation condition being satisfied.

14. The computer of claim 13, wherein the activation condition is based on a speed at which the first vehicle is traveling.

15. A method comprising:
training a machine-learning model to match ground-truth vibration data generated by a second vibration sensor, the second vibration sensor being mounted to a second component of a second vehicle, the second vibration sensor being of a second type;
receiving first vibration data detected by a first vibration sensor, the first vibration sensor being of a first type different than the second type, the first vibration sensor being mounted to a first component of a first vehicle, the first vehicle including a coupled dynamic system including the first component and the second component, the second component of the first vehicle lacking any vibration sensor mounted thereto;
executing the machine-learning model to determine a numerical quantity of vibrational energy transferred to the second component, the first vibration data being an input to the machine-learning model, the numerical quantity of vibrational energy being specific to the second component of the first vehicle; and
actuating a third component of the first vehicle based on the numerical quantity of vibrational energy.

16. The method of claim 15, wherein the first type is a road noise cancellation (RNC) accelerometer, and the second type is an internal circuit piezoelectric (ICP) sensor.

17. The method of claim 15, wherein:
the coupled dynamic system includes a plurality of second components including the second component, each of the second components lacking any vibration sensor mounted thereto;
the machine-learning model is trained to match the ground-truth vibration data generated by a plurality of second vibration sensors respectively mounted to the second components; and
each second vibration sensor is of the second type.

18. The method of claim 17, wherein the machine-learning model is a one-to-many regression model.

19. The method of claim 15, wherein the coupled dynamic system is a suspension system of a wheel of the first vehicle, and the first component is a control arm.

20. The method of claim 15, further comprising, before training the machine-learning model, processing the ground-truth vibration data by applying a bandpass filter, wherein a frequency band of the bandpass filter is based on a coherence analysis of the ground-truth vibration data.
